(19) United States
(12) Patent Application Publication
(10) Pub. No.: US 2021/0373147 A1
(43) Pub. Date: Dec. 2, 2021

(54) TRACKING A TARGET USING DOPPLER SHIFT

(71) Applicants: Todd Moon, Providence, UT (US); Thomas Bradshaw, Logan, UT (US)

(72) Inventors: Todd Moon, Providence, UT (US); Thomas Bradshaw, Logan, UT (US)

(73) Assignee: Utah State University, Logan, UT (US)

(21) Appl. No.: 17/332,556

(22) Filed: May 27, 2021

Related U.S. Application Data
(60) Provisional application No. 63/030,813, filed on May 27, 2020.

(51) Int. Cl. G01S 13/72; G01S 13/534

(52) U.S. Cl. CPC G01S 13/723; G01S 13/534

(57) ABSTRACT

For tracking a target, a method receives a first target signal reflected by a target for a first transmitter/receiver pair. The method receives a second target signal reflected by the target for a second transmitter/receiver pair or transmitter signal characteristics for a transmitter of the first transmitter/receiver pair. The method determines Doppler frequencies based on the first target signal and the second target signal or the transmitter signal characteristics. The method determines a target position and a target velocity vector for the target based on the Doppler frequencies.

### FIELD

The subject matter disclosed herein relates to tracking a target and more particularly relates to tracking a target using Doppler shift.

### BACKGROUND

### Description of the Related Art

A target location may be needed.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a target system;

FIG. 1B is a schematic block diagram illustrating one alternate embodiment of a target system;

FIG. 1C is a schematic block diagram illustrating one alternate embodiment of a target system;

FIG. 1D is a schematic block diagram illustrating one embodiment of a carrier offset;

FIG. 2 is a schematic block diagram illustrating one embodiment of Doppler information;

FIG. 3 is a schematic block diagram illustrating one embodiment of a transmitter/receiver pair;

FIG. 4 is a schematic block diagram illustrating one embodiment of a computer;

FIG. 5A is a schematic flow chart diagram illustrating one embodiment of a tracking method;

FIG. 5B is a schematic flow chart diagram illustrating one embodiment of a Doppler frequency estimation method;

FIG. 5C is a schematic flow chart diagram illustrating one alternate embodiment of a Doppler frequency estimation method;

FIG. 6 is a drawing illustrating one embodiment of a target positions; and

FIG. 7 is a graph illustrating one embodiment of tracking.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing computer readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in computer readable code and/or software for execution by various types of processors. An identified module of computer readable code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of computer readable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a computer readable signal medium or a computer readable storage medium. The computer readable storage medium may be a storage device storing the computer readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable code embodied therein, for example, in baseband or as part of a carrier wave. Such a propagated signal may take any of a variety of forms, including, but not limited to, electro-magnetic, optical, or any suitable combination thereof. A computer readable signal medium may be any storage device that is not a computer readable storage medium and that can communicate, propagate, or transport a program for use by or in connection with an instruction execution system, apparatus, or device. Computer readable code embodied on a storage device may be transmitted using any appropriate medium, including but not limited to wireless, wire line, optical fiber cable, Radio Frequency (RF), etc., or any suitable combination of the foregoing.

Computer readable code for carrying out operations for embodiments may be written in any combination of one or more programming languages, including an object-oriented programming language such as Python, Ruby, R, Java, Java Script, Smalltalk, C++, C sharp, Lisp, Clojure, PHP, or the like and conventional procedural programming languages, such as the “C” programming language or similar programming languages. The computer readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by computer readable code. These computer readable code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The computer readable code may also be loaded onto a computer, other programmable data processing apparatus, or other devices to cause a series of operational steps to be performed on the computer, other programmable apparatus, or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable code.

The transmitter may be a mobile telephone network. The transmitter may also employ a WiFi network based on any one of the Institute of Electrical and Electronics Engineers (IEEE) 802.11 standards. Alternatively, the transmitter may be a BLUETOOTH® connection. In addition, the transmitter may employ a Radio Frequency Identification (RFID) communication including RFID standards established by the International Organization for Standardization (ISO), the International Electrotechnical Commission (IEC), the American Society for Testing and Materials (ASTM), the DASH7 Alliance, and EPCGlobal.

Alternatively, the transmitter may employ a ZigBee connection based on the IEEE 802 standard.

Alternatively, the transmitter may be a cellular telephone network communication. All standards and/or connection types include the latest version and revision of the standard and/or connection type as of the filing date of this application.

Moon, Todd, “Tracking a Moving Target Using Doppler Shift” Utah State University, Apr. 22, 2020 is incorporated herein by reference. Bradshaw, Thomas, “Alternative Doppler Extraction for Indoor Communication Signals” Utah State University, Apr. 30, 2020 is incorporated herein by reference.

The problem of locating and tracking a target is one which has been widely explored. For example, in a setting using mobile robots, it is desirable for the robot to know its position, and for devices or humans which interact with the robot to know its position. Locating and tracking airplanes has a long history, using for example, any of several different modalities of radar. Geolocation on the earth, using for example the GPS system, is another example of locating.

Several different methods have been developed to perform geolocation. For example, Time of Arrival (TOA) techniques, such as GPS location, make use of signals transmitted from specialized satellites and the time differences from several satellites to the receiver to identify position. This requires a sophisticated satellite infrastructure and precisely controlled timing information. Another method of location, generally referred to as time difference of arrival (TDOA) makes use of time differences of a signal at different receivers. In TDOA, the time difference of a transmitted signal received at two receivers determines a locus of points where the transmitter could be. By employing multiple pairs of transmitters, the transmitter location can be determined. This technique, however, requires precise synchronization between the transmitters. Received signal strength can be used as a method of location. Since the strength of a received signal decreases with the distance from the transmitter, the received signal strength at several receivers can be used to determine the location of a transmitter. Direction of arrival (DOA) methods employ the ability of a receiver to determine the direction from which a transmitted signal arrives, such as using an antenna array. All of these methods require that the target transmit a signal.

A different approach to location is to actively query the location of the target using an approach such as radar or (in an acoustic setting) sonar.

The method of the embodiments differs from the techniques summarized above because it does not require the target to transmit any signal, nor does it require active querying as in radar. Instead, the method makes use of radio (or in an acoustic setting, sound) signals already present in the vicinity of the target. These signals might come, for example, from a Wi-Fi transmitter or a radio station. Because this makes use of a signal transmitter at a location different from the receivers, it may be viewed as a form of bi-static radar. However, this does not require that the transmitted signal be designed for particular radar purposes, but may use a variety of incident signals. The method makes use of Doppler changes in the received signal due to motion between the target and the receivers.

An advantage of the embodiments is that they do not require that the receivers by closely synchronized. While information is shared among the receivers to estimate position and velocity of the target, this does not require the very tight synchronization required by other methods such as TOA and TDOA. Receiver share Doppler information, synchronized to within the target tracking requirements of the system, and not to within the timing requirements to estimate, for example, phase differences between receivers.

An additional advantage of this system is that it can take advantage of existing signals, without requiring additional signaling for purposes of tracking. For example, in a mobile robot setting, it is not required that specialized signals be provided for location—communication infrastructure within the region can put to dual use for location as well.

A further advantage of this system is that it may operate covertly. It may be desirable to locate and track a target without the target being aware that it is being tracked, for example in a surveillance application. The target may not be transmitting, and any signal directed toward the target (e.g., radar), may enable the target to learn that its motion is being tracked. By making use of incidental radio signals in the area, surveillance tracking is possible without an indication to the target that it is being tracked.

The embodiments may be used in a variety of settings. For example, it may be used within a building to track moving targets, such as mobile robots or persons within the building. It may also be used on the scale of a city or an airspace to track targets such as vehicles or aircraft. In another application, the target may be fixed, with the transmitters and receivers are moving relative to the target.

For convenience, positions and velocities are described using two-dimensional coordinates. However, the embodiments may be generalized to three-dimensional coordinates when a target is moving with three positional degrees of freedom.

In many applications, the transmitters will be fixed, such as when commercial radio transmitters or WiFi routers. But the embodiments also encompasses the situation where the transmitters are moving relative to the target.

Multiple transmitters can be advantageously accommodated when the signals that they transmit are, for example, bandpass signals occurring in different bands. The receivers can separately receive the signal from each transmitter in this case by performing complex basebanding using a carrier appropriate for the band in which the transmitter is transmitting.

The description of elements in each figure may refer to elements of proceeding figures. Like numbers refer to like elements in all figures, including alternate embodiments of like elements.

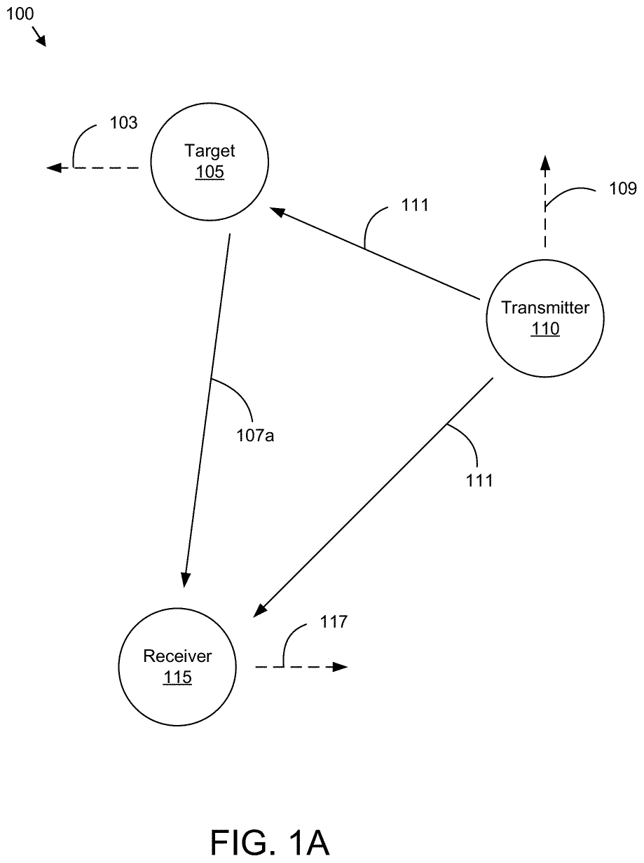

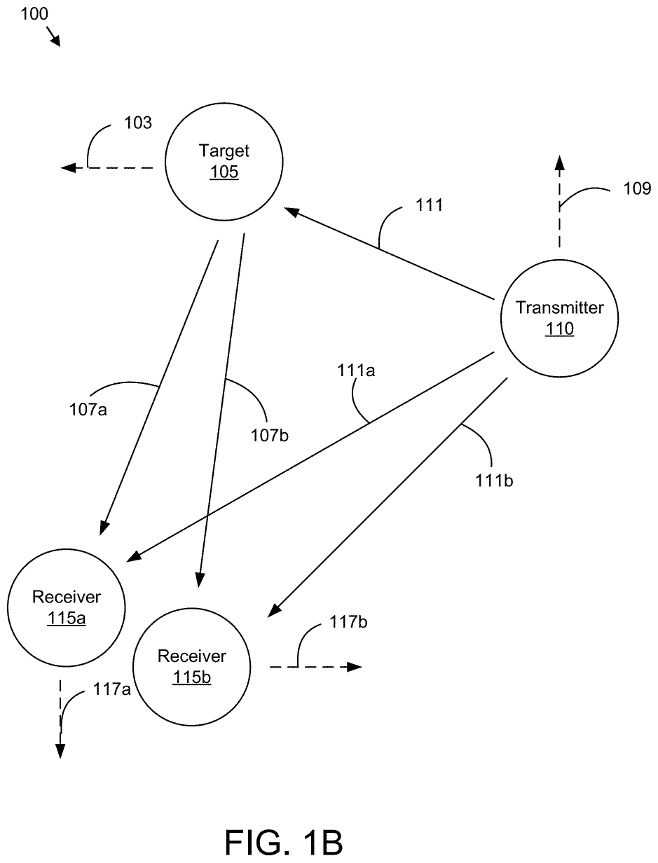

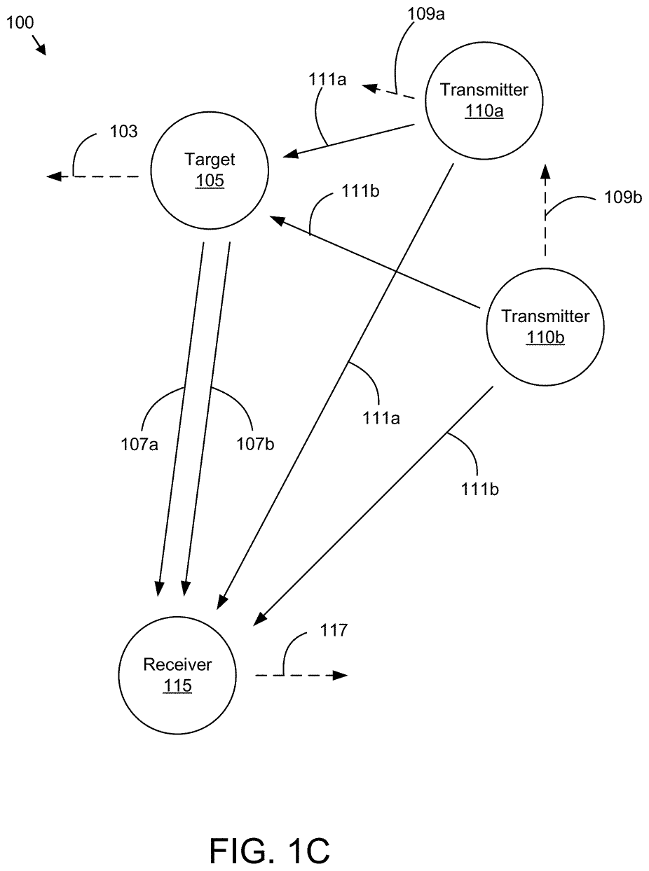

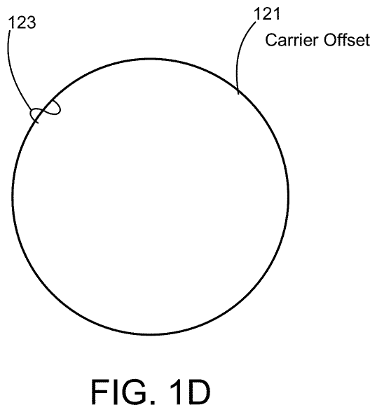

FIG. 1A is a schematic block diagram illustrating one embodiment of a target system 100. The system 100 includes a target 105, at least one transmitter 110, and at least one receiver 115. The target 105 may be in motion with a target velocity vector 103. The transmitter 110 may be in motion with transmitter velocity vector 109. The receiver 115 may be in motion with the receiver velocity vector 117.

The transmitter 110 may broadcast a transmitter signal 111. The transmitter signal 111 may be reflected by the target 105 as a target signal 107. The receiver 115 may receive the target signal 107. The receiver 115 may also receive the transmitter signal 111.

FIG. 1B is a schematic block diagram illustrating one alternate embodiment of the target system 100. In the depicted embodiment, two receivers 115 are shown. Each receiver 115a-b may have a unique receiver velocity vector 117a-b.

FIG. 1C is a schematic block diagram illustrating one alternate embodiment of 100 target system 100. In the depicted embodiment, two transmitters 110a-b are shown. Each transmitter 110a-b may have a unique transmitter velocity vector 109a-b.

FIG. 1D is a schematic block diagram illustrating one embodiment of a carrier offset 121 of a transmitter signal 111 relative to a target signal 107. In the depicted embodiment, the carrier offset 121 is a repeating sinusoid. A Doppler rotation 123 modifies the carrier offset 121 based on movement of the target 105.

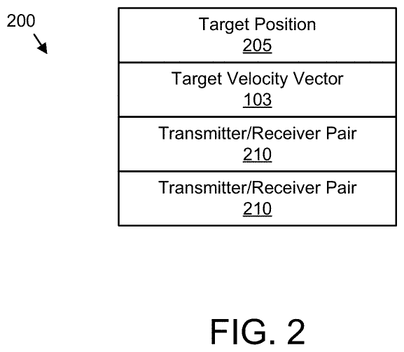

FIG. 2 is a schematic block diagram illustrating one embodiment of Doppler information 200. The Doppler information 200 may be organized a data structure and a memory. In the depicted embodiment, the Doppler information 200 includes a target position 205, the target velocity vector 103, and one or more transmitter/receiver pairs 210.

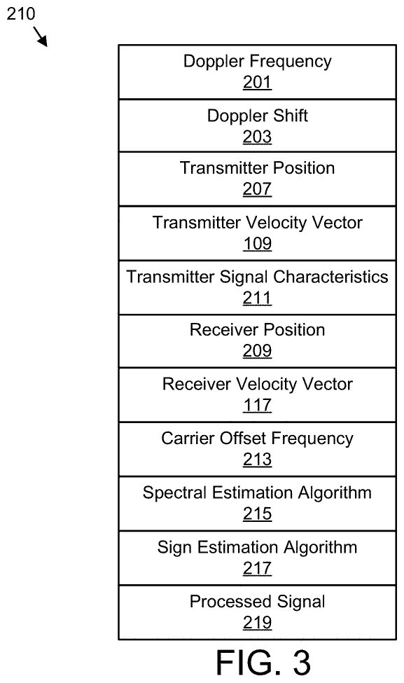

The target position 205 and/or target velocity vector 103 may be calculated for each target 105 from a Doppler frequency 201 as will be described hereafter. Each transmitter/receiver pair 210 may record data for a transmitter 110 and a receiver 115. The transmitter/receiver pair is described in more detail in FIG. 3.

FIG. 3 is a schematic block diagram illustrating one embodiment of a transmitter/receiver pair 210. In the depicted embodiment, the transmitter/receiver pair 210 includes a Doppler frequency 201, a Doppler shift 203, the transmitter position 207, the transmitter velocity vector 109, transmitter signal characteristics 211, a receiver position 209, the receiver velocity vector 117, a carrier offset frequency 213, a spectral estimation algorithm 215, a sign estimation algorithm 217, and a processed signal 219.

The Doppler frequency 201 may be a frequency of a Doppler shift 203 of a target signal 107. The Doppler frequency 201 may be calculated as will be described hereafter. The Doppler shift 203 may be a change in frequency from a transmitter signal 111 to a target signal 107.

The transmitter position 207 identifies a spatial position of the transmitter 110 of the transmitter 110/receiver 105 pair. The transmitter velocity vector 109 is a vector describing the change of position of the transmitter 110. The transmitter signal characteristics 211 may describe a frequency of the transmitter signal 111, a strength of the transmitter signal 111, and the like.

The receive position 209 identifies a spatial position of the receiver 104. The receiver velocity vector 117 describes the change of position of the receiver 105. The carrier offset frequency 213 may be calculated for each target signal 107 as will be described hereafter.

The spectral estimation algorithm 215 may be selected from the group consisting of a MUltiple SIgnal Classification (MUSIC) algorithm, a Discrete Fourier Transform (DFT) algorithm, a Viterbi algorithm, a Bahl, Cocke, Jelinek and Raviv (BCJR) algorithm, and a BCJR algorithm in conjunction with the Viterbi algorithm.

The sign estimation algorithm 217 may estimate a sign of the Doppler frequency 201. The sign estimation algorithm 217 may be a maximum likelihood algorithm. The processed signal 219 may have a DC component, and a frequency component f_{d} as will be described hereafter.

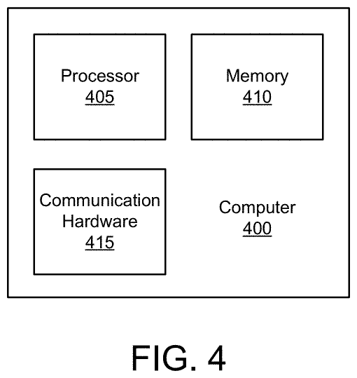

FIG. 4 is a schematic block diagram illustrating one embodiment of a computer 400. In the depicted embodiment, the computer 400 includes a processor 405, a memory 410, and communication hardware 415. The memory 410 may include a semiconductor storage device, a hard disk drive, an optical storage device, or combinations thereof. The memory 410 may store code. The processor 405 may execute the code. The communication hardware 415 may communicate with other devices such as the receiver 115.

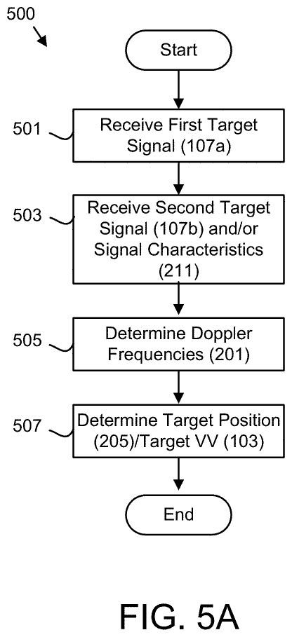

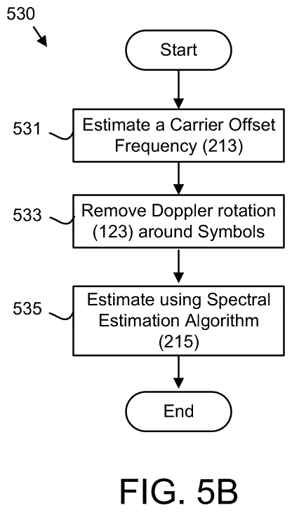

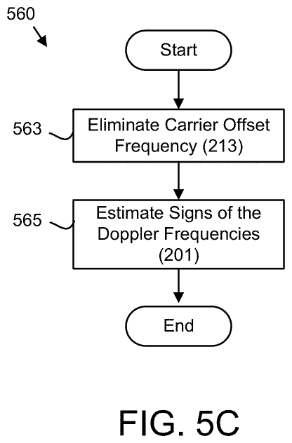

FIG. 5A is a schematic flow chart diagram illustrating one embodiment of a tracking method 500. The method 500 may be performed by the processor 405. The processor 405 may receive 501 a first target signal 107a reflected by a target 105 for a first transmitter/receiver pair 210a. The processor 405 may receive 503 a second target signal 107b reflected by the target 105 for a second transmitter/receiver pair 210b or transmitter signal characteristics 211 for a transmitter 110 of the first transmitter/receiver pair 210a.

The processor 405 may determine 505 Doppler frequencies 201 based on the first target signal 107a and the second target signal 107b or the transmitter signal characteristics 211. Embodiments of the determination 505 of the Doppler frequencies 201 is described in more detail in FIGS. 5B-C.

The processor 405 may determine 507 a target position 205 and a target velocity vector 103 for the target (105) based on the Doppler frequencies 201.

In one embodiment, νⱼ(t)=(x_{T,j}(t), y_{T,j}(t)), j=1, 2, . . . , J, denotes the known position of a (possibly moving) transmitter 110, denoted as transmitter j 110, producing a signal sⱼ(t).

The velocity of transmitter j 110 is shown in Equation 1.

$${V}_{T , j} ( t ) = ( \frac{d}{dt} {x}_{T , j} ( t ) , \frac{d}{dt} {y}_{T , j} ( t ) ) = ( {v}_{T , j , x} ( t ) , {v}_{T , j , y} ( t ) ) \qquad Eq . 1$$

In one embodiment, tⱼ(t)=(x_{R,k}(t), y_{R,k}(t)) denotes the known positions of (possibly moving) receivers k 115, for k=1, . . . , K, with velocities as shown in Equation 2.

$${v}_{T , j} ( t ) = ( \frac{d}{dt} {x}_{R , k} ( t ) , \frac{d}{dt} {y}_{R , k} ( t ) ) = ( {v}_{R , k , x} ( t ) , {v}_{R , k , y} ( t ) ) \qquad Eq . 2$$

In one embodiment, g(t)=(x(t), y(t)) denotes the position of a single moving target 105, moving with a target velocity vector ν(t) of Equation 3.

$$v ( t ) = ( \frac{d}{dt} x ( t ) , \frac{d}{dt} y ( t ) ) = ( {v}_{x} ( t ) , {v}_{y} ( t ) ) \qquad Eq . 3$$

The embodiments take measurements of target signals 107 (e.g., a radio or acoustic signal) at the receiver positions 209, and from that estimate the target position 205 and target velocity vector 103 of the target 105 as a function of time. Equation 4 may be a unit vector in the direction of the receiver velocity vector 117 from receiver positions ₖ(t) to (t) 209.

$${\hat{u}}_{R , k} ( t ) = \frac{g ( t ) - {q}_{k} ( t )}{‖ g ( t ) - {q}_{k} ( t ) ‖} \qquad Eq . 4$$

Equation 5 may denote a unit vector in the direction of the transmitter velocity vector 109 from transmitter positions tⱼ(t) to g(t) 207. R_{T,j} (t) may denote the range (distance) from transmitter j to target, and R_{R,k} (t) may denote the range from target 105 to receiver k 115.

$${\hat{u}}_{T , j} ( t ) = \frac{( t ) - {}_{j} ( t )}{‖ ( t ) - {}_{j} ( t ) ‖} \qquad Eq . 5$$

The Doppler frequency at receiver k 115 due to the target signal 107 from transmitter j 110 produced by the relative motion of the transmitter, receiver, and target is given by Equation 6, where f₀ is the transmitted frequency (e.g., for a sufficiently narrowband signal with carrier f_{c}, f₀=f_{c})).

$${f}_{d , k , j} ( t ) = - \frac{1}{λ} ( \frac{{dR}_{T , j} ( t )}{dt} + \frac{{dR}_{R , k} ( t )}{dt} ) = - \frac{{f}_{0}}{c} ( \frac{{dR}_{T , j} ( t )}{dt} + \frac{{dR}_{R , k} ( t )}{dt} ) , \qquad Eq . 6$$

The sign in Equation 6 is such that if, for example, R_{R,k}(t) is decreasing (target 105 moving toward the receiver 115) the Doppler frequency is positive. The changes in path lengths are given by the projections of (t) onto the respective unit vectors of Equations 7.

$$\begin{matrix}\frac{{dR}_{T , j}}{dt} = & proj ( v ( t ) - {v}_{T , j} ( t ) , {\hat{u}}_{T , j} ( t ) ) = \\ & ( v ( t ) - {v}_{T , j} ( t ) ) \cdot \hat{u} ( t ) \\ = & ( {v}_{x} ( t ) - {v}_{T , j , x} ( t ) , {v}_{y} ( t ) - {v}_{T , j , y} ( t ) ) \cdot \\ & \frac{( x ( t ) , y ( t ) ) - ( {x}_{T , j} ( t ) , {y}_{T , j} ( t ) )}{‖ ( x ( t ) , y ( t ) ) - ( {x}_{T , j} ( t ) , {y}_{T , j} ( t ) ) ‖}\end{matrix} \\ \begin{matrix}\frac{{dR}_{R , k} ( t )}{dt} = & proj ( v ( t ) - {v}_{R , k} ( t ) , {\hat{u}}_{R , k} ( t ) ) \\ = & ( {v}_{x} ( t ) - {v}_{R , k , x} ( t ) , {v}_{y} ( t ) - {v}_{R , k , y} ( t ) ) \cdot \\ & \frac{( x ( t ) , y ( t ) ) - ( {x}_{R , k} ( t ) , {y}_{R , k} ( t ) )}{‖ ( x ( t ) , y ( t ) ) - ( {x}_{R , k} ( t ) , {y}_{R , k} ( t ) ) ‖}\end{matrix} \qquad Eq . 7$$

Hence, Equation 8.

$${f}_{d , j , k} ( x ( t ) , y ( t ) , {v}_{x} ( t ) ) , {v}_{y} ( t ) = - \frac{{f}_{0}}{c} [ ( {v}_{x} ( t ) , {v}_{y} ( t ) ) \cdot ( \begin{matrix}\frac{( x ( t ) , y ( t ) ) - ( {x}_{T , j} ( t ) , {y}_{T , j} ( t ) )}{‖ ( x ( t ) , y ( t ) ) - ( {x}_{T , j} ( t ) , {y}_{T , j} ( t ) ) ‖} + \\ \frac{( x ( t ) , y ( t ) ) - ( {x}_{R , k} ( t ) , {y}_{R , k} ( t ) )}{‖ ( x ( t ) , y ( t ) ) - ( {x}_{R , k} ( t ) , {y}_{R , k} ( t ) ) ‖}\end{matrix} ) - ( {v}_{T , j , x} ( t ) , {v}_{T , j , y} ( t ) ) \cdot \frac{( x ( t ) , y ( t ) ) - ( {x}_{T , j} ( t ) , {y}_{T , j} ( t ) )}{‖ ( x ( t ) , y ( t ) ) - ( {x}_{T , j} ( t ) , {y}_{T , j} ( t ) ) ‖} - ( {v}_{R , k , x} ( t ) , {v}_{R , k , y} ( t ) ) \cdot \frac{( x ( t ) , y ( t ) ) - ( {x}_{R , k} ( t ) , {y}_{R , k} ( t ) )}{‖ ( x ( t ) , y ( t ) ) - ( {x}_{R , k} ( t ) , {y}_{R , k} ( t ) ) ‖} ] \\ j = 1 , 2 , … , J , i = 1 , 2 , … , K . \qquad Eq . 8$$

The Doppler shift 203 is thus a function of both target position (x(t), y(t)) 205 and target velocity vector (νₓ(t), ν_{y}(t)) 103. To determine the target position 205 and the target velocity vector 103 from the target signals 107 received at the receivers 115, two fundamental signal processing operations may be employed. The first is the extraction of the Doppler frequencies at each receiver. The second is to take those Doppler frequencies and determine the position and velocity of the target, consistent with Equation 8.

A signal from transmitter j to receiver k is denoted as sⱼₖ(t). However, in the discussion below, this will be denoted generically as s(t) and the Doppler shift due to the relative motions will be denoted as f_{d} (expressed in Hz). The signal s(t) is assumed to be represented as a complex signal. (A person of ordinary skill in the art will understand how to represent a real signal as a complex signal, such as by employing a Hilbert transform.) At a receiver there is a direct path signal and the signal reflected from the moving target. Taking the direct path signal as the reference for time and amplitude, the signal at a receiver can be written as Equation 9.

r(t)=s(t)+αs(t−τ₀)e^{j2πf}^{_{d}}^{^{t}}+n(t) Eq. 9

Here, j is the complex unit=\sqrt{−1}, α is attenuation due to the additional path distance on the reflected path compared to the direct path; τ₀ is the additional delay between the direct path and the reflected path; f_{d} is the Doppler due to relative motions among the transmitter, target, and receiver, as described by Equation 8; and n(t) is additive noise introduced, for example, at the receiver.

### Extracting Doppler Information

From this received signal the Doppler frequency f_{d} is to be extracted. One way to achieve this is to form the complex ambiguity function (CAF) by Equation 10.

A(τ,F)=∫_{-∞}^{∞}r(t)r*(t−τ)e^{j2πFt}dt Eq. 10

This ambiguity function may be searched to find a position (τ, F) which maximizes |A(τ, F)|. Since the primary variable of interest in this application is the Doppler frequency, in some applications it may suffice to determine τ only approximately.

In one particular embodiment, the transmitted signal is a digital communication waveform, such as a quadrature amplitude modulated (QAM) signal or a signal produced by Wi-Fi other other communication device. This can be generalized to other digital communication waveforms. Accordingly, let Equation 11,

s(t)= [symbol] p(t− [symbol] Tₛ) Eq. 11

where Tₛ denotes the symbol period; [symbol] represent a series of points drawn from a signal space; and p(t) is the baseband pulse-shaping waveform. The received signal at a receiver is Equation 12.

r(t)= [symbol] p(t− [symbol] Tₛ)+αΣ [symbol] a [symbol] p(t− [symbol] Tₛ−τ₀)e^{j2πf}^{_{d}}^{^{t}}+n(t) Eq. 12

In Equation 12, a carrier offset between the transmission signal 111 and the target signal 107 are known and/or removed by a phase lock loop and/or phase information shared between the transmitter 110 and the receiver 115.

In some operating scenarios the delay τ₀ may be such that the delay time is inconsequential compared to the time scale of p(t) as shown in Equation 13,

p(t)≈p(t−τ₀) Eq. 13

so that the received signal may be represented as Equation 14.

r(t)=Σ [symbol] a [symbol] p(t− [symbol] Tₛ)+αΣ [symbol] a [symbol] p(t− [symbol] Tₛ)e^{2πf}^{_{d}}^{^{t}}+n(t) Eq. 14

In some operating scenarios, the attenuation factor α may be quite small, due, for example, to a small cross section of the target. When the received signal is passed through a filter matched to the pulse p(t), the matched filter output [symbol] corresponding to symbol [symbol] can be represented to sufficient fidelity as Equation 15,

[symbol]

= [symbol] + [symbol] +ν Eq. 15

where F_{d}=f_{d}Tₛ represents the Doppler frequency signal sampled once per symbol time; ϕ is some phase, and ν is the filtered noise. When a is small, the term [symbol] may be regarded as small perturbation to the received signal. The matched filter output may be passed through a decision block to obtain an estimate [symbol] of the symbol. Then the matched filter output can be represented as Equation 16,

[symbol]

= [symbol] + [symbol] +ν Eq. 16

yielding Equation 17, wherein a carrier offset between the transmitter signal 111 and the target signal 107 is removed by the matched filter.

$$\frac{{z}_{ℓ} - {\hat{a}}_{ℓ}}{{\hat{a}}_{ℓ}} \approx α {e}^{ϕ} {e}^{j 2 π {F}_{d} ℓ} + v \qquad Eq . 17$$

The Doppler-shifted target signal 107 may be conceived as a phasor rotating around the signal point [symbol] as shown in FIG. 1D. A sequence of the numbers

$$\frac{{z}_{ℓ} - {\hat{a}}_{ℓ}}{{\hat{a}}_{ℓ}}$$

can be Fourier transformed, for example using a fast Fourier transform, after which the Doppler frequency 201 can be determined by identify peaks in the transformed signal.

In one embodiment, the Doppler frequencies 201 are extracted at the receiver positions 209 of the receivers 115, so that the only information that needs to be shared among the receivers 115 is the Doppler information such as Doppler frequencies 201. It is thus not necessary to precisely synchronize the receivers 115 at the level that would be required, for example, to extract the phase difference between different receivers 115.

Knowing the Doppler frequencies 201 on the path from each transmitter 110 to each receiver 115, obtained using techniques such as those described above, the Equations 8 are used to determine x(t), y(t), νₓ(t) and ν_{y}(t). This may be done on a discrete-time basis, with updates produced every Tₚ seconds, where Tₚ is determined according to the dynamics of the system. For example, for tracking a walker target 105 within a room, selecting Tₚ=0.5 seconds may suffice, producing a new update of target position 205 and target velocity vector 103 every 0.5 seconds. In an airplane target setting, it may suffice to set Tₚ=5 seconds. Accordingly, Equation 8 may evaluated at t=nTₚ. Let x(n), y(n), νₓ(n), ν_{y}(n) be an abbreviated notation for x(nTₚ), y(nTₚ), νₓ(nTₚ), ν_{y}(nTₚ), and similarly for x_{T}, y_{T}, and so forth. Let f_{d,j,k}(n) denote the Doppler information at time nTₚ from the signal from transmitter j 110 to receiver k 115.

In one embodiment, the target position 205 and the target velocity vector 103 may be extracted by formulating a cost functional of Equation 18.

$$Eq . 18 \\ J ( x ( n ) , y ( n ) , {v}_{x} ( n ) , {v}_{y} ( n ) ) = {\sum }_{j = 1}^{J} {\sum }_{k = 1}^{K} {{( {f}_{d , j , k} ( n ) + \frac{{f}_{0}}{c} [ ( {v}_{x} ( n ) , {v}_{y} ( n ) ) \cdot \\ ( \frac{( x ( t ) , y ( t ) ) - ( {x}_{T , j} ( t ) , {y}_{T , j} ( t ) )}{‖ ( x ( t ) , y ( t ) ) - ( {x}_{T , j} ( t ) , {y}_{T , j} ( t ) ) ‖} + \\ \frac{( x ( t ) , y ( t ) ) - ( {x}_{R , k} ( t ) , {y}_{R , k} ( t ) )}{‖ ( x ( t ) , y ( t ) ) - ( {x}_{R , k} ( t ) , {y}_{R , k} ( t ) ) ‖} ) - ( {v}_{t , k , x} ( n ) , {v}_{T , k , y} ( n ) ) \cdot \\ \frac{( x ( n ) , y ( n ) ) - ( {x}_{T} ( n ) , {y}_{T} ( n ) )}{‖ ( x ( n ) , y ( n ) ) - ( {x}_{T , j} ( n ) , {y}_{T , j} ( n ) ) ‖} - ( {v}_{R , k , x} ( n ) , {v}_{R , k , y} ( n ) ) \cdot \\ \frac{( x ( n ) , y ( n ) ) - ( {x}_{R , k} ( n ) , {y}_{R , k} ( n ) )}{‖ ( x ( n ) , y ( n ) ) - ( {x}_{R , k} ( n ) - {y}_{R , k} ( n ) ) ‖} ] )}^{2} }^{2} \qquad$$

The embodiments may find parameters which minimize the cost function of Equation 19.

(\hat{x}(n),ŷ(n),\hat{ν}ₓ(n),\hat{ν}_{y}(n))=argmin_{x(n),y(n),ν}_{ₓ}_{(n),ν}_{_{y}}₍ₙ₎J(x(n),y(n),νₓ(n),ν_{y}(n)) Eq. 19

This minimization may be accomplished by any of several methods, such as gradient descent or Newton's method, starting from some initial condition.

In another embodiment, an extended Kalman filter or a second-order extended Kalman filter may be employed. To this end, a state vector is defined in Equation 20.

$$x ( n ) = [ \begin{matrix}x ( n ) \\ y ( n ) \\ {v}_{x} ( n ) \\ {y}_{n} ( x )\end{matrix} ] \qquad Eq . 20$$

A dynamics equation for this state. In one embodiment, this may be written as Equation 21,

x(n+1)=ax(n)+w(n) Eq. 21

where A describes the dynamics. In one embodiment the dynamics are expressed as Equation 22,

$$A = [ \begin{matrix}1 & 0 & {T}_{p} & 0 \\ 0 & 1 & 0 & {T}_{p} \\ 0 & 0 & 1 & 0 \\ 0 & 0 & 0 & 1\end{matrix} ] \qquad Eq . 22$$

Certain emodiments may incorporate additional information, such as representing inputs to the system. The observation equation is based on the relationship between the Doppler information and the position and velocity parameters. The observation vector is given by Equation 23.

$$y ( n ) = [ \begin{matrix}{f}_{d , 1 , 1} ( n ) \\ {f}_{d , 2 , 1} \\ ⋮ \\ {f}_{d , J , 1} \\ ⋮ \\ {f}_{d , J , K} ( n )\end{matrix} ] \qquad Eq . 23$$

FIG. 5B is a schematic flow chart diagram illustrating one embodiment of a Doppler frequency estimation method 530. The method 530 may estimate a Doppler frequency 201. In one embodiment, the method performs step 505 of FIG. 5A. The method 530 may be performed by a processor 405.

The method 530 starts, and in one embodiment, the processor 405 estimates 531 a carrier offset frequency 213 for each of the first target signal 107a and the second target signal (107b). The carrier offset frequency 213 may be estimated 561 between the transmission signal 111 and the target signal 107 received by the receiver 115. Since an amplitude of the transmission signal 111 β is much greater than the target signal 107 \tilde{β}, it is possible to estimate the carrier offset frequency fₑ 213 using a spectral estimation algorithm 215, including the DFT or the MUSIC algorithm.

The spectral estimation algorithm 215 may also include methods to produce a continuous carrier frequency estimate. These methods may include using the Viterbi algorithm, the BCJR algorithm, or the BCJR algorithm in conjunction with the Viterbi algorithm. \hat{f}ₑ may denote the estimated carrier offset frequency 213, with \hat{f}ₑ≈fₑ.

In one embodiment, a modified Viterbi algorithm spectral estimation algorithm 215 may be employed to estimate 531 the carrier offset frequency 213. The modified Viterbi algorithm may include a branch metric with a magnitude of a frequency bin of state k ν(k) as shown in Equation 24 and a transition penalty μ(k,j) that may measure path deviation. In one embodiment, this may be as shown in Equation 25 where j and k are states.

ν(k)=abs(X[k=f/N]) Eq. 24

μ(k,j)=K|k−j| Eq. 25

The transition penalty may limit transitions to other frequencies. K is a control variable that lowers path values.

The processor 405 may remove 533 the carrier offset frequency 213 for each target signal 107 to yield the processed signal 219 comprising a Direct Current (DC) component and the Doppler frequency 201 for each target signal 107. In one embodiment, each target signal 107 is multiplied by e^{-j2}^{_{πfe}}^{^{k}} to remove the carrier offset frequency 213, to form the processed signal \tilde{z}ₖ 219 as shown in Equation 26. The target signal at a point in the receiver 115 may be written as zₗ=βaₗ+\tilde{β}aₗe^{j2πf}^{^{e1}} where fₑ represents a carrier frequency offset 213 between a transmitter carrier and a receiver carrier.

$${\tilde{z}}_{k} = {z}_{k} {e}^{- j 2 π {f}_{e}^{k}} \approx β + \tilde{β} {e}^{j 2 π {f}_{d}^{k}} + noise . \qquad Eq . 26$$

The processor 405 may estimate 535 the Doppler frequency 201 for each target signal 107 and the method 530 ends. The processed signal 219 has a DC component, and a frequency component f_{d}. The frequency component f_{d} may be estimated using the spectral estimation algorithm 215. The spectral estimation algorithm 215 may also include methods to produce a continuous carrier frequency estimate 535 the Doppler frequency. These methods may include using the Viterbi algorithm, or the BCJR algorithm, or the BCJR algorithm in conjunction with the Viterbi algorithm.

In one embodiment, a matrix of probabilities is calculated using Equation 27. A transition value γₜ(p, q) is calculated for describing the transitions between states p, q, where K1, K2, and δ are non-zero constants.

$${γ}_{t} ( p , q ) = \{ \begin{matrix}{e}^{{K}_{2} v ( p )} {e}^{- {K}_{1} \vert p - q \vert} , & if \vert p = q \vert < δ \\ 0 , & otherwise\end{matrix} \qquad Eq . 27$$

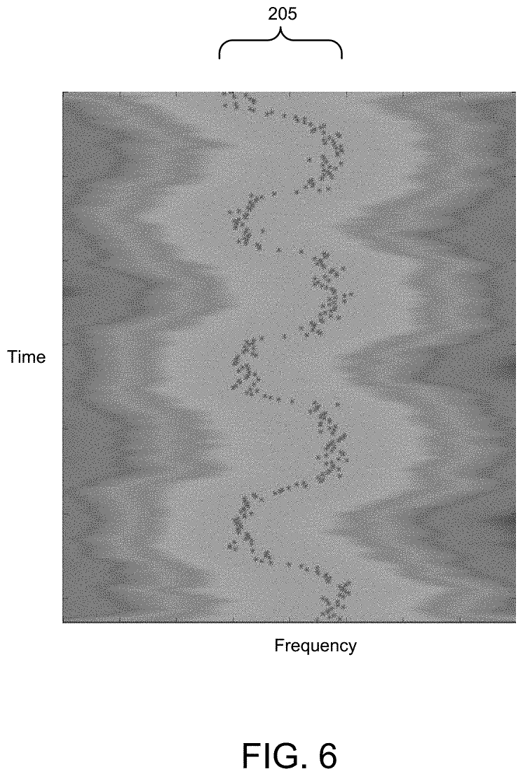

The Viterbi algorithm may be used to find a path through the matrix of probabilities that corresponds to the target position 205 as illustrated in FIG. 6.

FIG. 5C is a schematic flow chart diagram illustrating one alternate embodiment of a Doppler frequency estimation method 560. The method 560 may estimate a Doppler frequency 201. In one embodiment, the method performs step 505 of FIG. 5A. The method 560 may be performed by a processor 405.

The method 560 starts, and the processor 405 may eliminate 563 the carrier offset frequency 213 by multiplying zₖ by its conjugate zₖ*, to form the function wₖ as shown in Equation 28.

wₖ=zₖzₖ*=|β|²+|\tilde{β}|²+2 Re(β\tilde{β}*)cos(2πf_{d}k)+noise Eq. 28

The terms |β|²+|\tilde{β}|² constitute a DC component. The signal wₖ thus has spectral components at DC and at the Doppler frequency f_{d} 201. However, since the Doppler frequency f_{d} 201 now appears as the argument of a cosine function, the sign of Doppler frequency f_{d} 201 is not apparent from wₖ, so the absolute value f_{d} is obtained by a spectral estimation algorithm 215.

The processor 405 may estimate 565 the signs of the Doppler frequencies f_{d} 201. In one embodiment, the signs of the Doppler frequencies f_{d} 201 are estimated using a maximum likelihood technique sign estimation algorithm 217.

In the maximum likelihood technique, a likelihood function f (z1, z2, . . . , z_{K} s, fd, fe) is formulated. Here, z₁, z₂, . . . , z_{K} represent symbol-timed samples over a time period of interest. The likelihood function may be formed under the assumption that the noise is Gaussian. To formulate this, approximate target signal values of β and β^{˜} may be employed. The unknown conditioning quantity may be removed as shown in Equation 29.

f(z₁,z₂, . . . ,zₖ|s,|f_{d}|)=f(z₁,z₂, . . . ,zₖ|s,|f_{d}|,fₑ)p(fₑ)dfₑ Eq. 29

In Equation 29, p(fₑ) is a density representing the range of possible carrier offset frequency values. In practice the density would be assumed to uniform, and the integral would be evaluated by summing at sample points within the frequency range.

From this a likelihood ratio is computed using Equation 30.

$$λ = \frac{f ( z 1 , z 2 , … , zK \vert s = 1 , \vert fd \vert )}{f ( z 1 , z 2 , … , zK \vert s = - 1 \vert fd \vert )} \qquad Eq . 30$$

The value of λ determines an estimate of the sign of the frequency. If λ>1, the sign of the frequency is determined to be 1. If λ<1, the sign of the frequency is determined to be −1.

Equivalently, a logarithm of the likelihood ratio may be computed, and the sign of f_{d} determined from the sign of the log likelihood ratio.

FIG. 6 is a drawing illustrating one embodiment of target positions 205 plotted against time and frequency. Light shading corresponds to high transition values γₜ(p, q) and dark shading corresponds to low transition values.

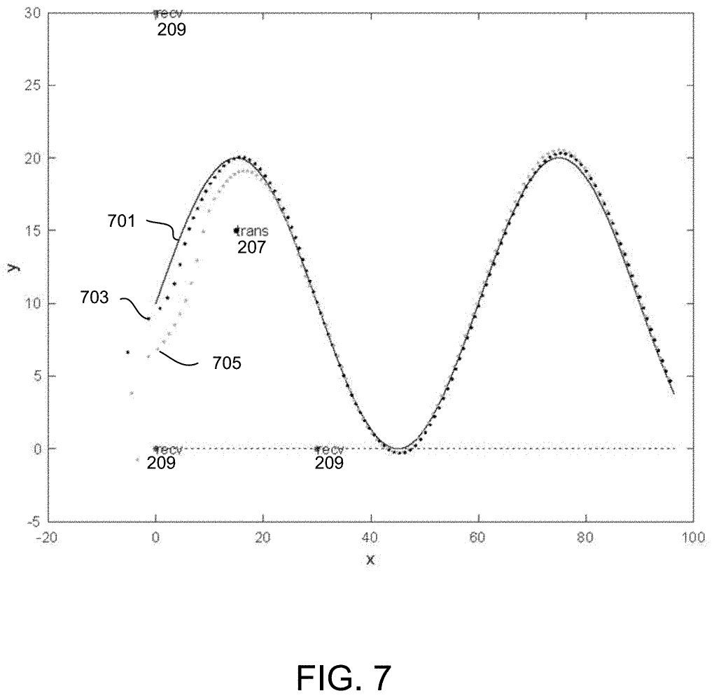

FIG. 7 is a graph illustrating one embodiment of tracking. A simulated track 701 portraying a person walking is shown in x and y spatial coordinates. Receiver positions 209 of receivers 115 and a transmitter position 207 of a transmitter 110 are also shown. The dots indicate the estimate target positions 205 computed using the extended Kalman filter 703 and second order extended Kalman filter 705.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, by use of a processor, a first target signal (107a) reflected by a target (105) for a first transmitter/receiver pair (210a);
receiving a second target signal (107b) reflected by the target (105) for a second transmitter/receiver pair (210b) or transmitter signal characteristics (211) for a transmitter (110) of the first transmitter/receiver pair (210a);
determining Doppler frequencies (201) based on the first target signal (107a) and the second target signal (107b) or the transmitter signal characteristics (211); and
determining a target position (205) and a target velocity vector (103) for the target (105) based on the Doppler frequencies (201).

2. The method of claim 1, wherein the Doppler frequencies (201) are determined by:
estimating a carrier offset frequency (213) for each of the first target signal (107a) and the second target signal (107b);
removing the carrier offset frequency (213) for each target signal (107) to yield a processed signal (219) comprising a Direct Current (DC) component and the Doppler frequency (201) for each target signal (107); and
estimating the Doppler frequency (201) for each target signal (107) from the processed signal (219) using a spectral estimation algorithm (215).

3. The method of claim 2, wherein each carrier offset frequency fₑ (213) is estimated using the spectral estimation algorithm (215) selected from the group consisting of a MUltiple SIgnal Classification (MUSIC) algorithm, a Discrete Fourier Transform (DFT) algorithm, a Viterbi algorithm, a Bahl, Cocke, Jelinek and Raviv (BCJR) algorithm, and a BCJR algorithm in conjunction with the Viterbi algorithm.

4. The method of claim 1, wherein the Doppler frequencies (201) are determined by:
eliminating a carrier offset frequency (213); and
estimating signs of the Doppler frequencies (201).

5. The method of claim 4, wherein the signs of the Doppler frequencies (201) are estimated using a sign estimation algorithm (217) comprising a maximum likelihood algorithm.

6. The method of claim 1, wherein a carrier offset frequency (213) between the transmitter signal (111) and the target signal (107) is known and/or removed by a matched filter, a phase locked loop, and/or phase information shared between the transmitter (110) and the receiver (115).

7. The method of claim 1, wherein the target signals (107) and/or transmitter signal characteristics (211) are time series and the Doppler frequencies (201) are determined by searching complex ambiguity functions based on the for the Doppler frequencies (201) that maximizes the complex ambiguity functions.

8. The method of claim 1, wherein the target position (205) and the target velocity vector (103) are determined by minimizing a function of a Doppler frequency time series. [Gradient descent, Newton's method]

9. The method of claim 1, wherein the target position (205) and the target velocity vector (103) are determined from a probability distribution for a Doppler frequency time series.

10. The method of claim 1, wherein for each transmitter/receiver pair (210), a transmitter velocity vector V_{T,j} (109) of the transmitter (110) or a receiver velocity vector V_{R,k} (117) of the receiver (115) is not equivalent to the velocity vector (103) of the target (105).

11. The method of claim 1, wherein a transmitter signal (111) of each transmitter/receiver pair (210) is not generated for determining position and/or p velocity of the target (105).

12. The method of claim 1, wherein a transmitter signal (111) of each transmitter/receiver pair (210) is selected from the group consisting of a commercial radio signal, a mobile telephone signal, and a wireless network signal.

13. The method of claim 1, wherein a transmitter signal (111) of each transmitter/receiver pair (210) is a digital communication signal.

14. The method of claim 1, wherein a transmitter signal (111) of each transmitter/receiver pair (210) is a quadrature amplitude modulated signal.

15. The method of claim 1, wherein the transmitter/receiver pair (210) of a receiver (115) and a transmitter (110) forms a triangle with the target (105) with no angle less than 2 degrees.

16. The method of claim 1, wherein a plurality of target signals (107) reflected by the target (105) for a plurality of transmitter/receiver pairs (210) is received and Doppler frequencies (201) are determined for each of the plurality of target signals (107).

17. An apparatus comprising:
a processor;
a memory storing code executable by the processor to perform:
receiving a first target signal (107a) reflected by a target (105) for a first transmitter/receiver pair (210a);
receiving a second target signal (107b) reflected by the target (105) for a second transmitter/receiver pair (210b) or transmitter signal characteristics (211) for a transmitter (110) of the first transmitter/receiver pair (210a);
determining Doppler frequencies (201) based on the first target signal (107a) and the second target signal (107b) or the transmitter signal characteristics (211); and
determining a target position (205) and a target velocity vector (103) for the target (105) based on the Doppler frequencies (201).

18. The apparatus of claim 17, wherein the Doppler frequencies (201) are determined by:
estimating a carrier offset frequency (213) for each of the first target signal (107a) and the second target signal (107b);
removing the carrier offset frequency (213) for each target signal (107) to yield a processed signal (219) comprising a Direct Current (DC) component and the Doppler frequency (201) for each target signal (107); and
estimating the Doppler frequency (201) for each target signal (107) from the processed signal (219) using a spectral estimation algorithm (215).

19. The apparatus of claim 17, wherein the Doppler frequencies (201) are determined by:
eliminating a carrier offset frequency (213); and
estimating signs of the Doppler frequencies (201).

20. A computer program product comprising a non-transitory computer readable storage medium comprising code executable by a processor to perform:
receiving a first target signal (107a) reflected by a target (105) for a first transmitter/receiver pair (210a);
receiving a second target signal (107b) reflected by the target (105) for a second transmitter/receiver pair (210b) or transmitter signal characteristics (211) for a transmitter (110) of the first transmitter/receiver pair (210a);
determining Doppler frequencies (201) based on the first target signal (107a) and the second target signal (107b) or the transmitter signal characteristics (211); and
determining a target position (205) and a target velocity vector (103) for the target (105) based on the Doppler frequencies (201).
